(19) United States
(12) Patent Application Publication
(10) Pub. No.: US 2024/0043243 A1
(43) Pub. Date: Feb. 8, 2024

(54) LOAD-BEARING COMPONENT, ELEVATOR AND METHOD

(71) Applicant: KONE Corporation, Helsinki (FI)

(72) Inventors: Tapio SIIRONEN, Helsinki (FI); Sami JANHUNEN, Helsinki (FI)

(73) Assignee: KONE Corporation, Helsinki (FI)

(21) Appl. No.: 18/381,329

(22) Filed: Oct. 18, 2023

Related U.S. Application Data
(63) Continuation of application No. PCT/FI2021/050309, filed on Apr. 27, 2021.

(51) Int. Cl. B66B 5/00; B66B 1/34

(52) U.S. Cl. CPC B66B 5/0025; B66B 1/3476; B33Y 80/00

(57) ABSTRACT

A load-bearing component, an elevator and a method of monitoring operation of an elevator are disclosed. The load bearing component includes at least one printed strain gauge. Sensing data is gathered from the printed strain gauge and based on the data, loadings directed to the elevator can be monitored.

### BACKGROUND OF THE INVENTION

The invention relates to a load-bearing component of an elevator. The component is provided with one or more strain gauges and is subjected to forces and stresses during use of the elevator.

The invention further relates to an elevator and method for monitoring operation of an elevator.

The field of the invention is defined more specifically in the preambles of the independent claims.

In elevators there are different needs to sense loadings directed to mechanical structures of the elevator. Forces, stresses, and material fatigues can be measured by means of a strain gauge. The strain gauges are typically so called foil strain gauges comprising long, thin conductive strips in zig-zag patterns of parallel lines. The strain gauges can be attached on monitored objects by suitable adhesives. As the object is deformed due to stresses, the foil is deformed, causing its electrical resistance to change. This resistance change is related to the strain and can be calculated in a control unit, for example. However, the known solutions have shown to contain some disadvantages.

### BRIEF DESCRIPTION OF THE INVENTION

An object of the invention is to provide a novel and improved load-bearing element, an elevator and a method for monitoring the elevator.

The load-bearing element according to the invention is characterized by the characterizing features of the first independent apparatus claim.

The elevator according to the invention is characterized by the characterizing features of the second independent apparatus claim.

The method according to the invention is characterized by the characterizing features of the independent method claim.

An idea of the disclosed solution is that a load-bearing component of an elevator is provided with one or more printed strain gauges for sensing strain on the component. In other words, The strain gauge arranged on the component is manufactured by the methods of printed electronics. Thus, the strain gauge serves as a load weighting device and comprises one or more printed circuit boards (PCB).

An advantage of the disclosed solution is that the printed strain gauge and related auxiliaries are cheaper and easier to manufacture and to install than the known foil strain gauges. The printing suits well for low-cost volume fabrication, and on the other hand, it allows an easy way to adjust the strain gauges for different purposes and locations in the elevator use. Further, the printed strain gauges can be produced and delivered flexibly. Due to the printing technology, the strain gauges may be small sized, and they can be arranged on nearly any surface shape and size.

According to an embodiment, the disclosed solution can be utilized determining weight of cargo inside an elevator car. The system can also be used for the purpose of structural health monitoring and needs of preventive maintenance, for example.

According to an embodiment, the strain gauge is printed on at least one substrate and the substrate is attached on an outer surface of the component by gluing agent, or in any other suitable fastening element or manner.

According to an embodiment, the strain gauge is formed directly on an outer surface of the component being monitored by means of additive manufacturing technology. In other words, the strain gauge can be manufactured directly on planar and even non-planar surfaces, by means of 3-D printing, for example.

According to an embodiment, the strain gauge is provided with a printed connecting wiring for communicating with at least one control unit or with a communication unit providing required data transmission with the control unit.

According to an embodiment, the strain gauge is connected to at least one wireless data communication device for communicating with at least one control unit.

According to an embodiment, in connection with the printed strain gauge there is also at least one antenna for wireless connectivity. This way the strain gauge may be provided with means utilizing WiFi™, NFC or other data communication protocols.

According to an embodiment, the strain gauge is provided with a RFID tag for providing the strain gauge with a passive radio frequency identification (RFID), whereby the strain gauge attached on the surface of the component is remotely communicated and powered by an external transmitter. In this solution not only the strain gauge but also the RFID tag is a printed circuit board.

According to an embodiment, the RFID-based technology allows the strain. gauge to be passive, i.e. operate without other power source such as batteries or cables. This is possible since the REID tag is capable of harvesting electromagnetic power from the communication signal emitted by an antenna of the RFDI reader. Then the strain gauge itself does not require other (internal) power sources and thus, serves as a battery less (passive) and wireless strain sensor.

According to an embodiment, the RFDI reader may be a handheld or portable electronic device which can be used by maintenance personnel, for example.

According to an embodiment, the RFID reader may be mounted to the structure of the elevator. Then the sensing device comprising the printable strain gauge and the RFID tag may be mounted on a movable component of the elevator and the RFID reader may activate the passive sensing device and communicate with it when the sensing device passes the RFIF reader transmitting signals by its antenna. This way, monitoring data may be gathered from the sensor each time when the RFID tag is inside a detection range of the RFID reader.

According to an embodiment, there may be two or more RFID readers or antennas for gathering data from the strain. gauge, whereby the sensing data can be received at two or more vertical locations of the car, for example. It is also possible that the same RFID reader or antenna can communicate with two or more different strain gauges provided with the RFID tags.

According to an embodiment, the printed strain gauge is provided with one or more additional printed electronic components or circuits. The additional components may relate to communication technology or they may be additional sensing components. Thus, in connection with the printed strain gauge there may be one or more pressure sensors, acceleration sensors, temperature sensors or any other printable sensors for sensing physical properties and circumstances.

According to an embodiment, the printed strain gauge is provided with printed collector elements for providing it with electrical connecting means which allow the printed system to communicate with other electrical devices, wirings or systems.

According to an embodiment, the load-bearing component is a rope fixing assembly for fixing at least one suspension rope of the elevator. The rope fixing assemblies are utilized for different types suspension ropes, hoisting ropes, and traction ropes.

According to an embodiment, the load-bearing component is a rope fixing assembly for fixing at least one suspension rope to an elevator car.

According to an embodiment, the load-bearing component is a rope fixing assembly for fixing at least one suspension rope to a counterweight assembly.

According to an embodiment, the load-bearing component is a rope fixing assembly for fixing at least one suspension rope to a fixed structure of the elevator. The rope fixing assembly may then serve as an anchoring point for ends of one or more suspension ropes. This kind of rope fixing assembly may also be called an anchoring element.

According to an embodiment, the load-bearing component is a suspension rope, or an intermediate element mounted between an end of the suspension rope and a fixing point of the suspension rope.

According to an embodiment, the load-bearing component is a mechanical element of a hoisting machinery.

According to an embodiment, the load-bearing component is a topmost suspension beam of an elevator car. Alternatively, the load-bearing component may be any other structural component configured to provide vertical support for the car assembly.

According to an embodiment, a traction rope is utilized in an elevator wherein a hoisting machinery is located at a bottom part of an elevator shaft. Then the traction rope is a load-bearing component and may be provided with one or more strain gauges which are in accordance with this document.

According to an embodiment, a compensation element, such as a compensation rope or chain, may be subjected to forces during the operation of the elevator. Then the compensation element may be considered to be a load-bearing component and may be provided with one or more strain gauges which are in accordance with this document. The generated data can used for generating data on condition of the compensation element, for example.

According to an embodiment, the load-bearing element is any element of the elevator that needs to be monitored because it is subjected to stresses during the use of the elevator. Thus, the disclosed strain gauge may belong to a preventive maintenance system of the elevator. Since the printable strain. gauges are low-cost and small in size, it is possible to implement them widely and thereby gather valuable sensing data for not only for controlling the maintenance but also for controlling operation of the elevator too. In other words, the printed strain gauge may be arranged to monitor any point of interest (POI) in the elevator.

According to an embodiment, the strain gauge is manufactured by ink-jet printing (IJP) technology. The IJP is a low cost method and easy to implement almost anywhere.

According to an embodiment, the printed strain gauge is ink-jet printed by using ink comprising silver, copper, or carbon.

According to an embodiment, the sensor structure is applied directly on surface of the monitored component with the help of ink-jet printing technology.

According to an embodiment, the strain gauge is screen printed on a substrate with carbon paste, for example.

According to an embodiment, the strain gauge is aerosol printed on a substrate by using silver nanoparticle ink. This technology is called an Aerosol jet-printing.

According to an embodiment, the printed strain gauge comprises a substrate which may made be of flexible foil, such as thin aluminum. Alternatively, the substrate may be a plastic film, for example. The strain gauge may be printed on a flexible substrate whereby the structure may be flexible and can be bent into desired shapes. This the strain gauge may be mounted not only on flat but also on curved surfaces.

According to an embodiment, the printed strain gauge comprises an encapsulation to protect the printed sensor. Thus, there may be one or more plastic films of other protective layers on the printed electric circuits.

According to an embodiment, the disclosed solution relates to an elevator comprising: an elevator car; at least one first guide assembly provided with first vertical guide rails mountable to the elevator shaft and first guide shoes mountable to the car assembly, and. wherein the guide shoes are supportable against the guide rails; a hoisting machinery for moving the car vertically inside an elevator shaft; and one or more strain. gauges configured to monitor one or more load-bearing components of the elevator. The mentioned one or more strain gauges are in accordance with any one of the features and embodiments disclosed in this document.

According to an embodiment, the elevator is a traction elevator and comprises: a counterweight assembly provided with a counterweight frame and at least one filler element; a second guide assembly provided with second vertical guide rails and second guide shoes for the counter-weight frame and wherein the mentioned guide shoes are supportable against. the guide rails; a hoisting machinery comprising an electric motor and a traction sheave driven by means of the electric motor; and at least one suspension rope connecting the car and the counterweight assembly and arranged to pass over the traction sheave. One or more printed strain gauges are mounted to one or more load bearing components which are subjected to stresses caused by cargo inside the car.

According to an embodiment, the traction elevator is a machine room. less elevator.

According to an embodiment, the elevator may is be a hydraulic elevator, or an; other type of an elevator.

According to an embodiment, the printed strain gauge is mounted to a load bearing component being part of a movable structure of the elevator. The printed strain gauge assembly may be provided with one or more remote readable tags. Then a fixed structural part of the elevator may be provided with one or more antennas for remotely activating the printed strain gauge for providing sensing data and activating the tag for transmitting sensing data in response to situation when tag is inside a range of the antenna. The electric waves transmitted by the antenna provides the strain gauge with required electric power for executing the sensing measures.

According to an embodiment, the disclosed solution relates to a method of monitoring operation of an elevator. The method comprises: providing one or more load-bearing components of the elevator with one or more strain gauges; and producing sensing data by means of the strain gauge and transmitting the sensing data to one or more control units for further processing. The method further comprises providing the mentioned one or more load-bearing components with one or more printed strain gauges.

According to an embodiment, the method comprises controlling operation of the elevator in response to the produced sensing data. of the strain gauge.

According to an embodiment, the method comprises utilizing the produced sensing data in operations of a preventive maintenance.

According to an embodiment, the method may further comprise: implementing the printed strain gauge as a load weighting device (LWD) of the elevator and examining load of cargo inside a car of the elevator in at least one control unit in response to sensing data gathered from the printed strain gauge.

Let it be mentioned that in this document the term “suspension rope” may refer to different type or rope systems and their suspension. ropes, hoisting ropes and traction ropes.

The above disclosed embodiments may be combined. in order to form suitable solutions having those of the above features that are needed.

### BRIEF DESCRIPTION OF THE FIGURES

Some embodiments are described in more detail in the accompanying drawings, in which

FIG. 1 is a schematic and highly simplified side view of a traction elevator,

FIG. 2 is a schematic and highly simplified partial side view of another traction elevator,

FIG. 3 is a schematic side view of a rope fixing assembly or anchoring provided with a load weighting arrangement,

FIG. 4 is a schematic side view of a system for remote reading data on a printed strain gauge,

FIG. 5 is a schematic diagram of some possible load-bearing components which may be equipped with printed strain gauges,

FIG. 6 is a schematic diagram of a strain gauge assembly and its possible printed components,

FIG. 7 is a schematic top view of a printed strain gauge and its components, and

FIG. 8 is a schematic top view of a strain gauge provided with wireless connectivity.

For the sake of clarity, the figures show some embodiments of the disclosed solution in simplified manner. In the figures, like reference numerals identify like elements.

### DETAILED DESCRIPTION OF SOME EMBODIMENTS

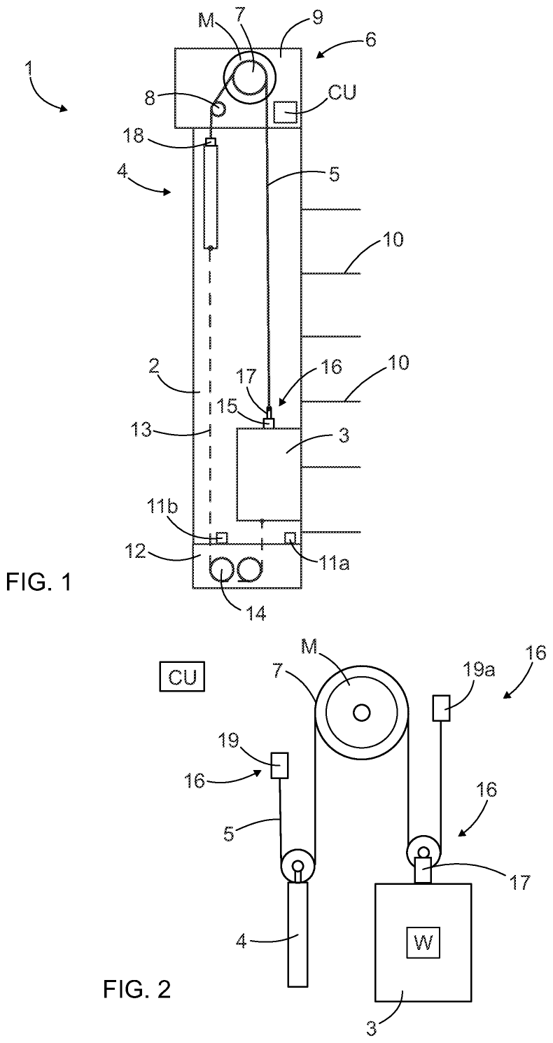

FIG. 1 discloses a traction elevator 1 mounted to an elevator shaft 2 of a building. The elevator 1 comprises an elevator car 3 for receiving load to be transported. The car 3 and a counterweight assembly 4 are suspended form a suspension rope 5 passing via a hoisting machinery 6. The hoisting machinery 6 comprises a traction. sheave 7 driven by means of an electric motor U. Between the suspension rope and the traction sheave 7 occurs friction which is utilized for transmitting lifting power to the elevator system. The hoisting machinery 6 may comprise one or more additional pulleys 8 for guiding and controlling the suspension rope 5. Further, different rope schemas and ratios may also be implemented. The roping ratio may be 1:1, 1:2 or 1:4, for example. The hoisting machinery 6 may be located at an upper machine room 9, or alternatively the system may be a so called machine room less elevator. The car 3 can be driven to desired. levels 10 or floors under control of one or more control units CU. Further, at a bottom of a pit 10 of the shaft 2 are buffers 11a, 11b. The buffer 11 is a device configured to stop the descending car 3 and the counter-weight 4 beyond its normal limit. The buffer 11 is arranged to soften the forces with which the elevator 1 runs into the pit 12 during special situations. Further, the bottom of the car 3 and a bottom of the counterweight assembly 4 are connected by means of a compensation element 13, such as a chain, rope or belt. The compensation element 13 may pass via a compensator pulley 14 located at the pit.

The disclosed solution utilizing printed strain gauges can be implemented in a versatile manner at different load-bearing structures and components of the elevator.

A frame structure of the elevator car 3 may comprise a topmost suspension beam 15 configured to support the frame vertically. Thus, the suspension beam 15 serves as a load-bearing component 16, which may be provided with the disclosed printed strain gauges. Alternatively, the frame structure may comprise one or more other type of support elements with any other shapes than the beam. Further, there may be a rope fixing assembly 17 for fixing the suspension ropes 5 to the car 3. Then, the rope fixing assembly 17 serves as the load-bearing component 16 and may be monitored by means of one or more printed strain gauges. There may be another rope fixing assembly 18 at the counterweight assembly 4 and it can also be equipped with the printed strain gauges.

Further, it is possible to provide the compensation element 13 with one or more printable strain gauges for producing data for preventive maintenance solutions, for example.

In an embodiment of the solution disclosed in FIG. 1, the sheave 7 may be a freely rotating sheave and the compensator sheave 14 of FIG. 1 may be substituted with a traction sheave and traction motor assembly. Then the compensation rope 13 is substituted with. a traction rope. The traction rope and its mounting assemblies may be provided with one or more disclosed printed strain gauges.

In FIG. 2 one or more suspension ropes 5 are anchored to the fixed structure of a traction elevator 1 by beans of an anchoring element 19, which. is another type of a rope fixing assembly and it serves as a load-bearing component 16. The anchoring element 19 may be provided with the disclosed pintable strain gauges. Alternatively, or in addition to, a car side rope fixing assembly 17 may be provided with the pintable strain gauges. The rope fixing assembly 17 may support a pulley. Further, there may be another anchoring element 19a or rope terminal for fixing the one or more ropes 5. The element 19a may be provided with one or more strain gauges which. are in accordance with the features disclosed in this document. Thus, there may be one, two or three disclosed load-bearing components 16 in this solution.

For clarity reasons the printed strain gauges are not shown in FIGS. 1 and 2.

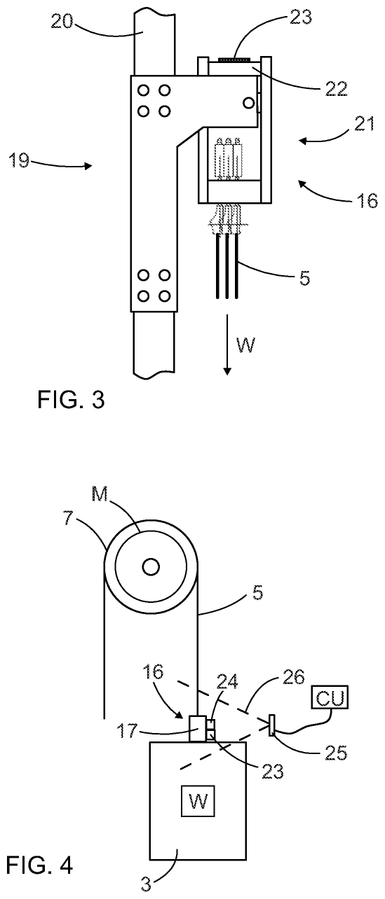

FIG. 3 discloses an anchoring element 19 for fastening suspension ropes 5 to a vertical structure 20 of an elevator. The anchoring element 19 may serve not only as a load-bearing component 16 but also as a load weighting device or unit. Weight W of cargo inside an elevator car 3 pulls a weighting frame 21 downwards via the ropes 5 and causes bending on a top part 22 of the weighting frame 21. There are one or more printed strain gauges 23 or strain gauge assemblies arranged on a top surface of the top part 22 which can sense the bending and extension on the top surface. Generated sensing data is transmitted to one or more control unit and the weight of the cargo can be calculated.

Further, the structure 21 may alternatively be mounted to a top part of an elevator shaft.

FIG. 4 discloses an arrangement wherein a rope fixing assembly 17 on top of an elevator car 3 is provided with a printed strain gauge 23 and a printed RFID tag 24. When the elevator car 3 moves up and down, it passes an antenna 25 mounted immovably to frame structures of the elevator or to an elevator shaft. The antenna 25 has a reading range 26 and when the RFID tag 24 is at reach of the reading range 26, then communication is formed between the tag and the antenna, and data transmission is possible. The antenna 25 may also provide the strain gauge 23 with the required electric energy so that the printed chip or circuit can be without any own electric energy storage. This way, the strain gauge assembly can be energized and read each time the elevator car 3 passes the antenna 25 and weight W of the elevator car 3 and its cargo can be calculated by means of a control unit CU. Thus, the system consists of passive RFID for data communication and a power supply.

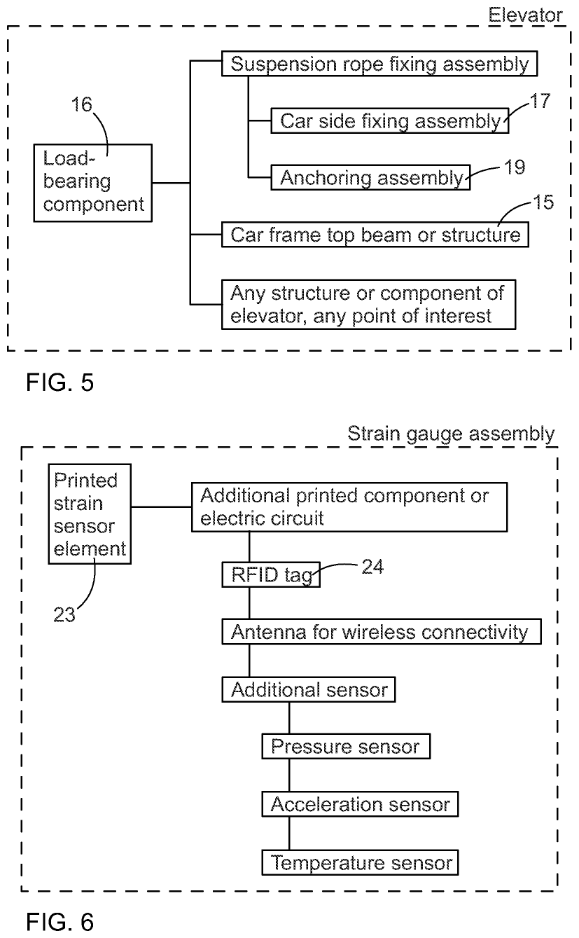

FIGS. 5 and 6 illustrate features that have already been disclosed above in this document.

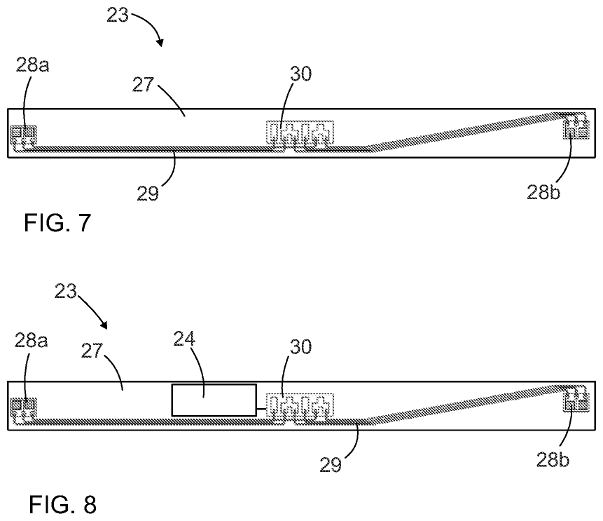

FIG. 7 discloses a printed strain gauge 23 comprising a substrate 27 on which strain gauge elements 28a, 28b are printed together with possible wirings 29 and collector parts 30 or data. communication units.

In FIG. 8 there is also shown a printed RFID tag 24 on the substrate 27. Further, it is also possible that the components of the strain. gauge 23 are 3D printed directly on a surface of a load-bearing component of an elevator. The strain gauge 23 is mounted or directly printed in areas that exhibit strain in compression or tension.

The drawings and the related description are only intended to us rate the idea of the invention. In its details, the invention may vary within the scope of the claims.

1. A load-bearing component of an elevator, comprising:
at least one strain gauge for sensing strain on the component,
wherein the at least one strain gauge is a printed strain gauge.

2. The component as claimed in claim 1, wherein the at least one strain gauge is printed on at least one substrate and the at least one substrate is attached on an outer surface of the component by a gluing agent.

3. The component as claimed in claim 1, wherein the at least one strain gauge is formed directly on an outer surface of the component being monitored by additive manufacturing technology.

4. The component as claimed in claim 1, wherein the at least one strain gauge is provided with a connecting wiring for communicating with at least one control unit.

5. The component as claimed in claim 1, wherein the at least one strain gauge is connected to at least one wireless data communication device for communicating with at least one control unit.

6. The component as claimed in claim 1, wherein the at least one strain gauge is provided with a RFD tag for providing the at least one strain gauge with a passive radio frequency identification (RFID), whereby the at least one strain gauge attached on the surface of the component is remotely communicated and powered by an external transmitter,

7. The component as claimed in claim 1, wherein the load-bearing component is a rope fixing assembly for fixing at least one suspension rope of the elevator.

8. The component as claimed in claim 1, wherein the load-bearing component is a topmost suspension beam of an elevator car.

9. The component as claimed in claim 1, wherein the at least one strain gauge is manufactured by ink-jet printing technology.

10. An elevator comprising:
an elevator car;
at least one first guide assembly provided with first vertical guide rails mountable to an elevator shaft and first guide shoes mountable to a car assembly, and wherein the guide shoes are supportable against the first guide rails;
hoisting machinery for moving the elevator car vertically inside the elevator shaft; and
at least one strain gauge configured to monitor at least one load-bearing component of the elevator;
wherein the at least one strain gauge is configured to sense strain on the component, and
wherein the at least one strain gauge is a printed strain gauge.

11. The elevator as claimed in claim 10, wherein the elevator is a traction elevator and further comprises:
a counterweight assembly provided with a counterweight frame and at least one filler element;
a second guide assembly provided with second vertical guide rails and second guide shoes for the counterweight frame and wherein the first and second guide shoes are supportable against the first and second vertical guide rails, respectively;
the hoisting machinery comprising an electric motor and a traction sheave driven by means of the electric motor; and
at least one suspension rope connecting the elevator car and the counterweight assembly and arranged to pass over the traction sheave, and
wherein the at least one printed strain gauge is mounted to the at least one load-bearing component being subjected to stresses caused by cargo inside the elevator car.

12. The elevator as claimed in claim 11, wherein the the at least one load-bearing component is a rope fixing assembly for fixing the at least one suspension rope.

13. The elevator as claimed in claim 10, wherein the at least one printed strain gauge is mounted to the at least one load-bearing component being part of a movable structure of the elevator,
wherein, in connection with the at least one printed strain gauge, is a remote readable tag, and
wherein a fixed structural part of the elevator is provided with at least one antenna for remotely activating the at least one printed strain gauge and the remote readable tag for providing and transmitting sensing data in response to a situation when the remote readable tag is inside a range of the at least one antenna.

14. A method of monitoring operation of an elevator, the method comprising the steps of:
providing at least one load-bearing component of the elevator with at least one strain gauge; and
producing sensing data by the at least one strain gauge and transmitting the sensing data to at least one control unit for further processing,
the step of providing the at least one load-bearing component with at least one strain gauge further comprises the step of providing the at least one load-bearing component with at least one printed strain gauge.

15. The method as claimed in claim 14, further comprising the steps of:
implementing the at least one printed strain gauge as a load weighting device of the elevator; and
examining a weight of cargo inside an elevator car in at least one control unit in response to sensing data gathered from the at least one printed strain gauge.

16. The component as claimed in claim 2, wherein the at least one strain gauge is provided with a connecting wiring for communicating with at least one control unit.

17. The component as claimed in claim 3, wherein the at least one strain gauge is provided with a connecting wiring for communicating with at least one control unit.

18. The component as claimed in claim 2, wherein the at least one strain gauge is connected to at least one wireless data communication device for communicating with at least one control unit.

19. The component as claimed in claim 3, wherein the at least one strain gauge is connected to at least one wireless data communication device for communicating with at least one control unit.

20. The component as claimed in claim 2, the at least one strain gauge is provided with a RFID tag for providing the at least one strain gauge with a passive radio frequency identification (RFID), whereby the at least one strain gauge attached on the surface of the component is remotely communicated and powered by an external transmitter.
